(19) United States
(12) Patent Application Publication
(10) Pub. No.: US 2023/0005293 A1
(43) Pub. Date: Jan. 5, 2023

(54) OBJECT DETECTION METHOD

(71) Applicant: NEC Corporation, Minato-ku, Tokyo (JP)

(72) Inventor: Yusuke TAKAHASHI, Tokyo (JP)

(73) Assignee: NEC Corporation, Minato-ku, Tokyo (JP)

(21) Appl. No.: 17/781,450

(22) PCT Filed: Dec. 17, 2019
(86) PCT No.: PCT/JP2019/049334

§ 371 Date: Jun. 1, 2022

(51) Int. Cl. G06V 40/16; G06V 10/22; G06V 10/26

(52) U.S. Cl. CPC G06V 40/165; G06V 10/22; G06V 10/267

(57) ABSTRACT

An object detection apparatus according to the present invention includes an object detecting unit configured to perform, for each region in an image set based on a size of a specific object detected in the image, a process of detecting the specific object on a new image.

### TECHNICAL FIELD

The present invention relates to an object detection method for detecting an object in an image, an object detection apparatus, and a program.

### BACKGROUND ART

In recent years, with the progress of image processing technology, security cameras are installed in various places to detect persons from images captured by the security cameras. For example, a security camera is installed in a place where many persons gather such as an airport, a station, a commercial facility and an event venue, and detection of a person is performed for a purpose such as checking the number of persons and the degree of congestion and performing a process of matching with previously registered persons such as criminals.

An example of a process of detecting a person from an image is described in Patent Document 1. In Patent Document 1, the image size of an input image is changed, and a face of a preset detection face size is detected.

Patent Document 1: Japanese Unexamined Patent Application Publication No. JP-A 2011-008704

However, the abovementioned technique described in Patent Document 1 needs a face detection process on the entire region of an input image whose image size has been changed, and has a problem that the speed of such a process cannot be increased. For example, in a case where an input image contains faces of a plurality of sizes as shown in FIG. 1, there is a need to change the image size of the input image a plurality of times and repeatedly perform the face detection process on the entire region of each input image whose image size has been changed. Moreover, not only in the case of detecting a face in an image but also in the case of detecting any object from an image, there arises a problem that the speed of a detection process cannot be increased.

### SUMMARY

Accordingly, an object of the present invention is to provide an object detection method, an object detection apparatus and a program that can solve the abovementioned problem that the speed of a process of detecting an object in an image cannot be increased.

An object detection method as an aspect of the present invention includes performing, for each region in an image set based on a size of a specific object detected in the image, a process of detecting the specific object on a new image.

Further, an object detection apparatus as an aspect of the present invention includes an object detecting unit configured to perform, for each region in an image set based on a size of a specific object detected in the image, a process of detecting the specific object on a new image.

Further, a computer program as an aspect of the present invention includes instructions for causing a processor of an information processing apparatus to execute performing, for each region in an image set based on a size of a specific object detected in the image, a process of detecting the specific object on a new image.

With the configurations as described above, the present invention can increase the speed of a process of detecting an object in an image.

### BRIEF DESCRIPTION OF DRAWINGS

FIG. 1 is a view showing an entire configuration of an information processing system in a first example embodiment of the present invention;

FIG. 2 is a block diagram showing a configuration of a detection apparatus disclosed in FIG. 1;

FIG. 3 is a view showing an example of processing by the detection apparatus disclosed in FIG. 1;

FIG. 4 is a view showing an example of processing by the detection apparatus disclosed in FIG. 1;

FIG. 5 is a view showing an example of processing by the detection apparatus disclosed in FIG. 1;

FIG. 6 is a view showing an example of processing by the detection apparatus disclosed in FIG. 1;

FIG. 7 is a view showing an example of processing by the detection apparatus disclosed in FIG. 1;

FIG. 8 is a view showing an example of processing by the detection apparatus disclosed in FIG. 1;

FIG. 9 is a view showing an example of processing by the detection apparatus disclosed in FIG. 1;

FIG. 10 is a view showing an example of processing by the detection apparatus disclosed in FIG. 1;

FIG. 11 is a view showing an example of processing by the detection apparatus disclosed in FIG. 1;

FIG. 12 is a flowchart showing a processing operation by the detection apparatus disclosed in FIG. 1;

FIG. 13 is a block diagram showing a hardware configuration of an object detection apparatus in a second example embodiment of the present invention;

FIG. 14 is a block diagram showing a configuration of the object detection apparatus in the second example embodiment of the present invention; and

FIG. 15 is a flowchart showing an operation of the object detection apparatus in the second example embodiment of the present invention.

### EXAMPLE EMBODIMENTS

### First Example Embodiment

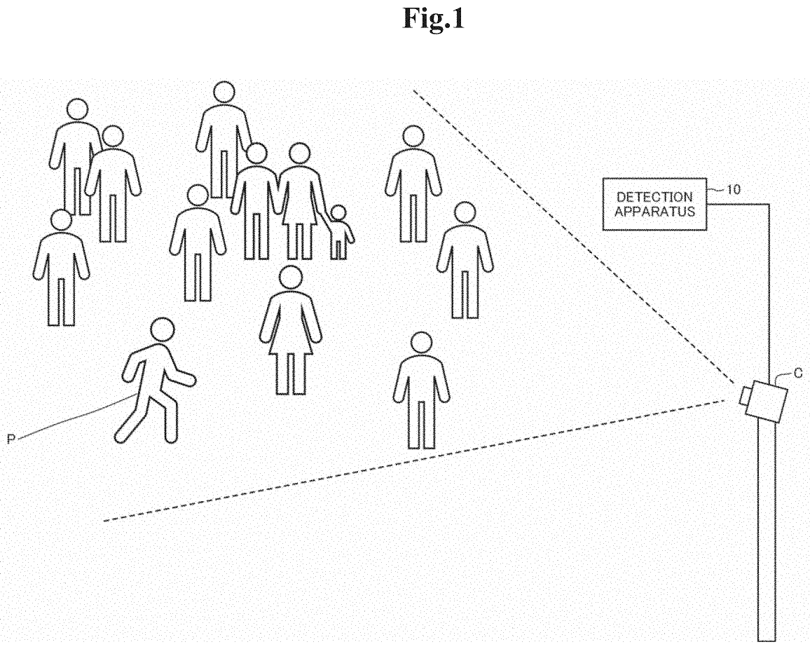

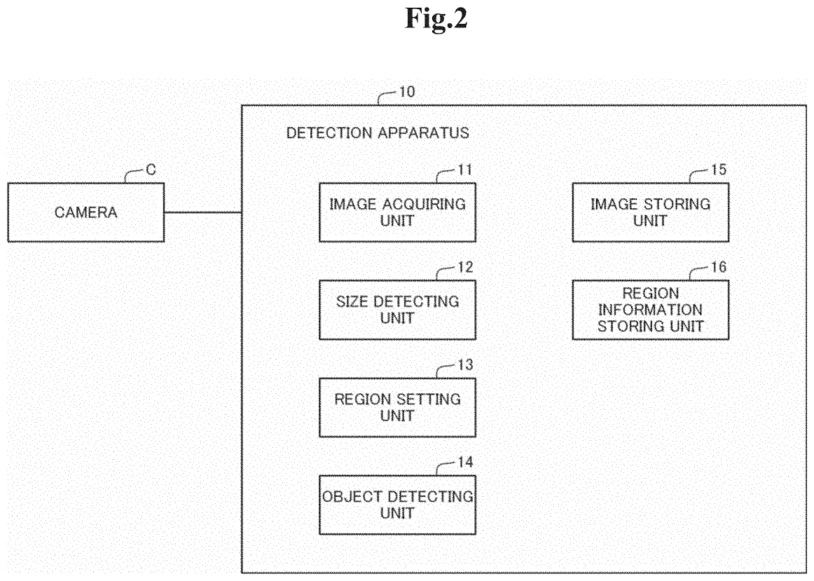

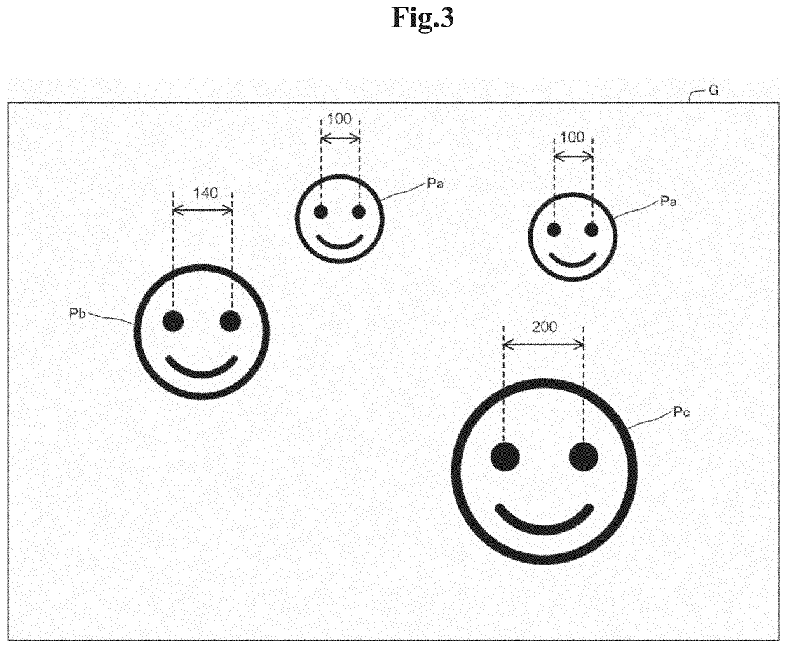

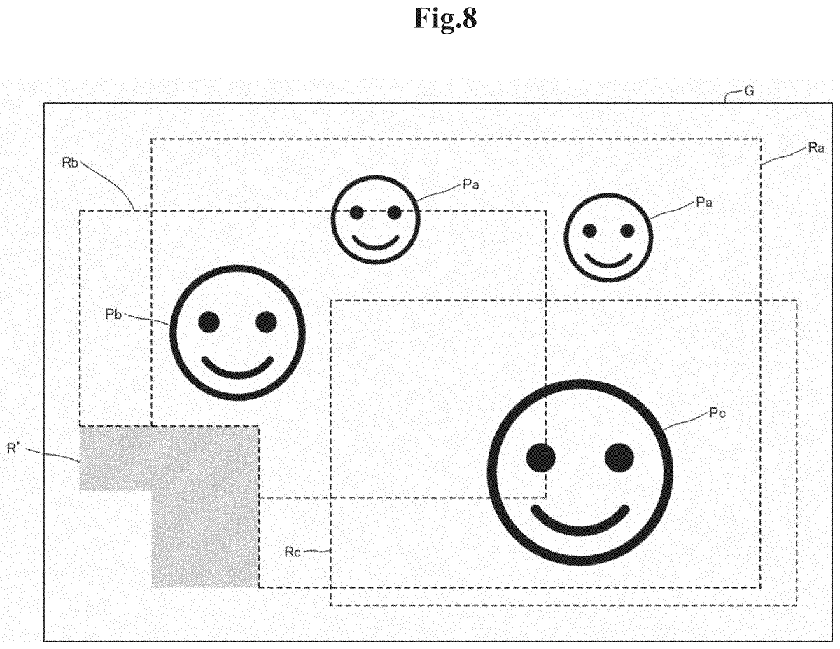

A first example embodiment of the present invention will be described with reference to FIGS. 1 to 12. FIGS. 1 to 2 are views for describing a configuration of an information processing system, and FIGS. 3 to 12 are views for describing a processing operation of the information processing system.

An information processing system according to the present invention is used for detecting the face of a person P who is in a place where many persons gather such as an airport, a station, a commercial facility and an event venue. For example, the information processing system detects the face of a person P who is in a target place to check the number of persons P and the degree of congestion in the place and to perform a process of matching with previously registered persons such as criminals. However, the information processing system according to the present invention is not limited to detecting the face of a person P for the abovementioned purpose, and may be used for detecting the face of a person P for any purpose. Moreover, the information processing system according to the present invention is not limited to detecting the face of a person P, and may detect any object.

[Configuration]

As shown in FIG. 1, the information processing system in this example embodiment includes a camera C for capturing an image of a space to be a target place, and a detection apparatus 10 (an object detection apparatus) that detects the face of a person P in the captured image. The detection apparatus 10 is configured by one or a plurality of information processing apparatuses including an arithmetic logic unit (a processor) and a storage unit.

The detection apparatus 10 includes, as shown in FIG. 2, an image acquiring unit 11, a size detecting unit 12, a region setting unit 13 and an object detecting unit 14 that are structured by execution of a program by the arithmetic logic unit. The detection apparatus 10 also includes an image storing unit 15 and a region information storing unit 16 that are formed in the storage unit. The respective components will be described in detail below.

The image acquiring unit 11 first accepts a captured image of a target place captured by the camera C at regular time intervals. For example, as shown in FIG. 3, the image acquiring unit 11 accepts a captured image including a plurality of faces of persons P and temporarily stores into the image storing unit 15. Although only one camera C is connected to the detection apparatus 10 in this example embodiment, a plurality of cameras C may be connected and processing as will be described later may be performed on captured images captured by the respective cameras C.

It is desirable for a target place captured by the camera C to be a place where, for each region in the captured range, that is, in the captured image, the position and size of the face of an appearing person are within certain ranges. For example, it is desirable to capture a place where many persons whose face sizes are within a certain range appear in the upper right region of the captured image and many persons whose face sizes are within a different certain range appear in the lower left region of the captured image. However, a target place captured by the camera C may be a place where the position and size of the face of an appearing person in each region are not known in advance.

The size detecting unit 12 (a size detecting unit) extracts a person P in a captured image based on the movement, shape, color and so on of an object shown in the captured image, and also detects the size of the face (a specific object) of the extracted person P. Specifically, in this example embodiment, the size detecting unit 12 detects the eye distance of a person P as the face size of the person P. For example, as mentioned above, the size detecting unit 12 detects an eye of a person P based on the movement, shape, color and so on of an object in a captured image, and detects the distance between the two eyes of a single person. As one example, the size detecting unit 12 calculates, for each of persons Pa, Pb and Pc shown in a captured image, an eye distance on image of each of the persons as shown in FIG. 3. FIG. 3 shows a case where the eye distances of the two persons Pa located on the upper side in the captured image are 100 pix (pixels), the eye distance of the person Pb located on the left side in the captured image is 140 pix (pixel), and the eye distance of the person Pc located on the right front side in the captured image is 200 pix (pixel).

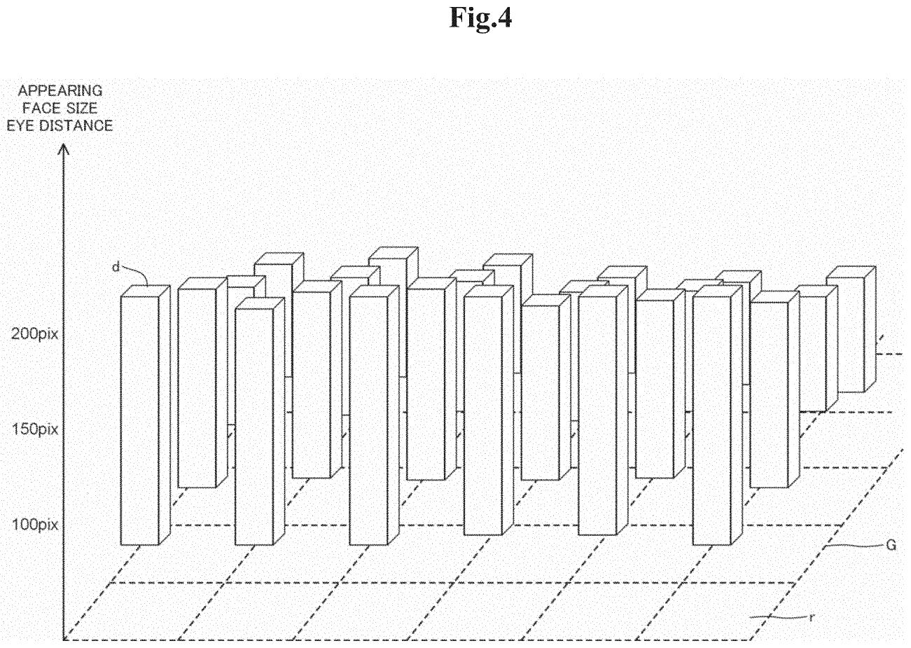

Then, the size detecting unit 12 stores so as to associate the detected eye distance of the person P and the position of the detected eyes of the person P on the captured image in the image storing unit 15. At this time, the size detecting unit 12 sets division regions r obtained by dividing an entire captured image G into a plurality of regions as indicated by dotted line in FIG. 4, and stores so as to associate the eye distance of the eyes of a person P located in a division region r and the division region r with each other. That is to say, the position of the face of a person P is represented by the position of a division region r in this example embodiment. However, the size detecting unit 12 may represent by another method, for example, represent the position of the face of a person P by the coordinates on a captured image.

The size detecting unit 12 detects the eye distance of a person P and stores so as to associate with a division region r in the same manner as described above for a plurality of captured images. Therefore, for each division region r, the eye distance of a person P located in the division region r is associated and stored in the image storing unit 15. As a result, no eye distance is associated with a division region r where no person P is detected, and a plurality of eye distances are associated with a division region r where a plurality of persons P are detected.

The region setting unit 13 (a region setting unit) sets a detection region R that is a region where a process of detecting the face of a person P is detected as will be described later on a captured image G, by using the eye distance of the person P detected as described above. At this time, the region setting unit 13 sets, for each reference eye distance, a detection region R so as to include a position where an eye distance determined to be identical to the value of the reference eye distance is detected. For example, the region setting unit 13 in this example embodiment sets reference eye distances to 100 pix, 150 pix and 200 pix, and sets detection regions Ra, Rb and Rc corresponding to the respective reference eye distances. The eye distances determined to be identical to the reference eye distances each have a range. As an example, the reference eye distance 100 pix has a range of 75 to 124 pix, the reference eye distance 150 pix has a range of 125 to 174 pix, for example, and the reference eye distance 200 pix has a range of 175 to 224 pix.

Specifically, the region setting unit 13 sets a detection region R in the following manner. First, the region setting unit 13 generates, for each division region r obtained by dividing a captured image G, a distribution d of eye distance associated with the division region r. For example, as shown in FIG. 4, the region setting unit 13 generates a distribution d of eye distance in association with each division region r so as to represent an eye distance detected in the division region r by a rod-shaped body extending from the minimum value to the maximum value on the vertical axis.

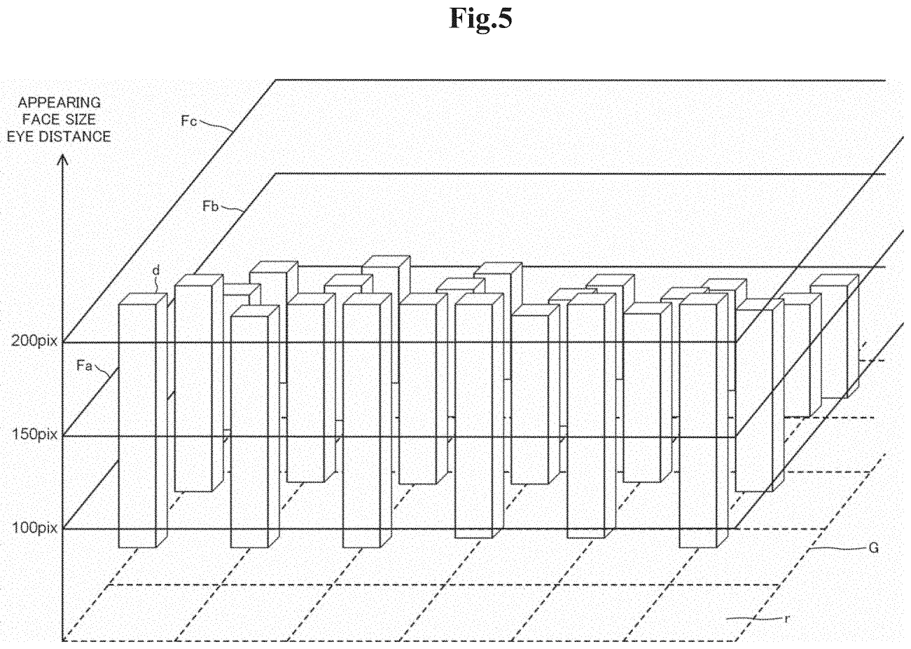

Then, the region setting unit 13 sets, for the respective reference eye distances 100 pix, 150 pix and 200 pix, planes Fa, Fb and Fc representing the height positions of the respective eye distances as shown in FIG. 5. Then, the region setting unit 13 sets a detection region R for each reference eye distance in accordance with a positional relation between each of the planes Fa, Fb and Fc and a rod-shaped body representing a distribution d of eye distance. In a case where a rod-shaped body representing a distribution d of eye distance passes through any of the planes Fa, Fb and Fc, the region setting unit 13 includes a division region r where the distribution d represented by the rod-shaped body is located as a detection region R of a reference eye distance corresponding to the plane. At this time, values within ranges determined to be identical to the values of the reference eye distances are also considered to pass through the respective planes Fa, Fb and Fc. For example, in a case where a reference eye distance is 100 pix, a distribution d of eye distance from 75 pix to 124 pix is also considered to pass through the plane Fa where the reference eye distance is 100 pix.

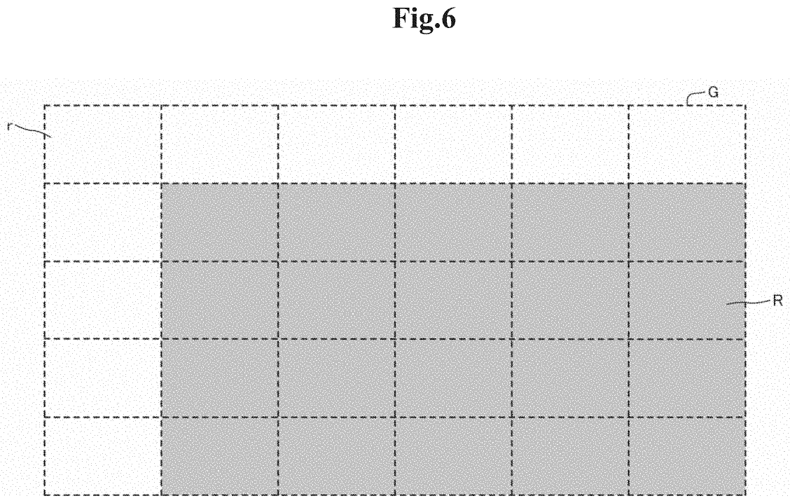

Then, the region setting unit 13 includes a division region r determined to pass through each of the planes Fa, Fb and Fc into a detection region R of a reference eye distance corresponding to each of the planes Fa, Fb and Fc. As an example, for a predetermined reference eye distance, a division region r where an eye distance within a range determined to be an identical value to the given reference eye distance is located is indicated by a gray region in FIG. 6. In this case, the region setting unit 13 sets a connection region where the division regions r indicated by the gray regions are connected, and sets the connection region as a detection region R corresponding to a predetermined reference eye distance. Thus, the region setting unit 13 sets, for each the reference eye distances (for example, 100 pix, 150 pix and 200 pix), a region where the face of a person P having an eye distance determined to be identical to the value of the reference eye distance (for example, 75 to 124 pix, 125 to 174 pix, and 175 to 224 pix) is located, as each of the detection regions Ra, Rb and Rc.

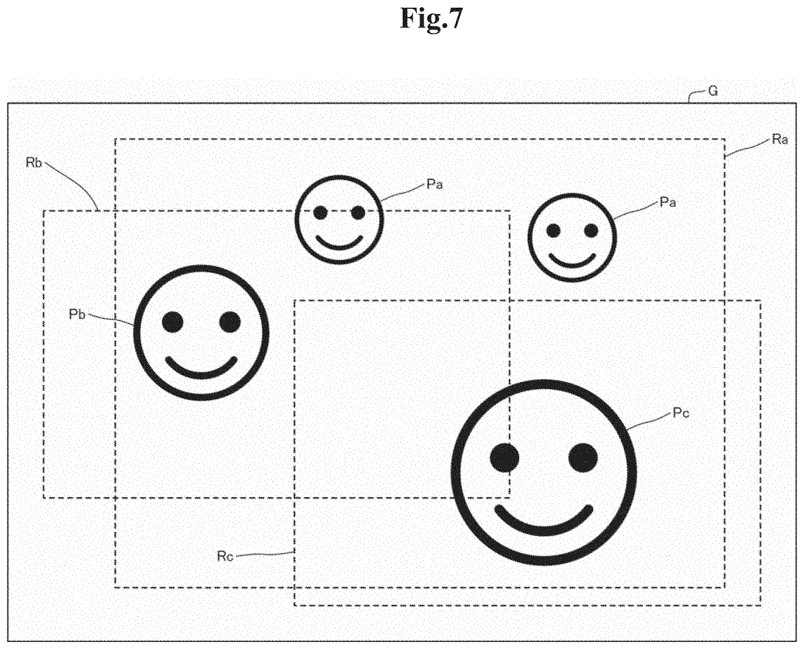

An example of the detection regions Ra, Rb and Rc set by the region setting unit 13 so as to correspond to the respective cases where a reference eye distance is 100 pix, 150 pix and 200 pix is shown in FIG. 7. For example, the detection region Ra set so as to correspond to a reference eye distance of 100 pix is a region where the face of a person Pa having an eye distance of 75 to 124 pix is detected, the detection region Rb set so as to correspond to a reference eye distance of 150 pix is a region where the face of a person Pb having an eye distance of 125 to 174 pix is detected, and the detection region Rc set so as to correspond to a reference eye distance of 200 pix is a region where the face of a person Pc having an eye distance of 175 to 224 pix is detected.

The region setting unit 13 may exclude a no-detection region R′ where the face of a person P, that is, an eye distance is not detected in a captured image from the detection regions Ra, Rb and Rc set as described above and then set final detection regions Ra, Rb and Rc. At this time, the region setting unit 13 may exclude not a unit of a division region r but a predetermined range around coordinates at which an eye distance is not detected in a captured image as a no-detection region and then set detection regions Ra, Rb and Rc.

Then, the region setting unit 13 stores region information that specify positions on captured image of the detection regions Ra, Rb and Rc set as described above into the region information storing unit 16. At this time, the region setting unit 13 stores so as to associate each of the region information of the detection regions Ra, Rb and Rc and information that specifies the image size of a new captured image to be the target of a process of detecting the face of a person P as will be described later with each other. The later face detection process is performed by detecting a face having a preset eye distance (for example, 100 pix). For this, information that specifies the image size of a new captured image is determined in accordance with a preset magnification of an eye distance at the time of performing the later face detection process with reference to the reference eye distance corresponding to each of the detection regions Ra, Rb and Rc.

For example, a case where detection of a face having an eye distance of 100 pix in a later face detection process is previously set will be described. In the case of an eye distance at the face detection process of 100 pix with reference to the reference eye distance of 100 pix, the magnification is 1 time, so that the face detection process can be performed by determining the image size of a new captured image to be 1 time as well. Therefore, information of “1 time” is associated with the detection region Ra corresponding to the reference eye distance of 100 pix as information that specifies the image size of a new captured image. Moreover, in the case of an eye distance at the face detection process of 100 pix with reference to the reference eye distance of 150 pix, the magnification is about 0.7 times, so that the face detection process can be performed by determining the image size of a new captured image to be 0.7 times as well. Therefore, information of “0.7 times” is associated with the detection region Rb corresponding to the reference eye distance of 150 pix as information that specifies the image size of a new captured image. Moreover, in the case of an eye distance at the face detection process of 100 pix with reference to the reference eye distance of 200 pix, the magnification is 0.5 times, so that the face detection process can be performed by determining the image size of a new captured image to be 0.5 times as well. Therefore, information of “0.5 times” is associated with the detection region Rc corresponding to the reference eye distance of 200 pix as information that specifies the image size of a new captured image.

The region setting unit 13 is not limited to associating the magnification of a new captured image as described above as information that specifies the image size of the new captured image to be associated with each of the region information of the detection regions Ra, Rb and Rc. For example, the region setting unit 13 may associate the image size of a new captured image, or may associate any other information.

The region setting unit 13 is not necessarily limited to setting the detection region R by the abovementioned method, and may set the detection region R by any method. Moreover, the abovementioned detection region R is not necessarily limited to being set by the region setting unit 13, and may be set beforehand by any method and stored into the region information storing unit 16.

The object detecting unit 14 (an object detecting unit) performs a process of detecting the face of a person P on a new captured image after a detection region R is set as described above. Specifically, the object detecting unit 14 acquires a new captured image captured by the camera C from the image acquiring unit 11, and changes the overall image size of the new captured image to a predetermined image size. For example, the object detecting unit 14 sequentially changes the overall image size of the new captured image to 1 time, 0.7 times, and 0.5 times. Then, the object detecting unit 14 acquires information of a detection region R associated with each of the magnifications of the changed overall image sizes of the new captured image from the region information storing unit 16. Furthermore, the object detecting unit 14 performs, on the new captured image of the changed image size, a process of detecting a face having an eye distance of 100 pix in the detection region R associated with the image size. The face detection process is performed by detecting an eye of a person in a captured image based on the movement, shape, color and so on of an object shown in the captured image, detecting the two eyes of a single person having a distance of 100 pix, and detecting a face region based on the position of the eyes. In the face detection process, a face region of an eye distance within a predetermined range before and after the eye distance of 100 pix is also detected. For example, a face region of an eye distance from 75 to 124 pix is also detected in a captured image.

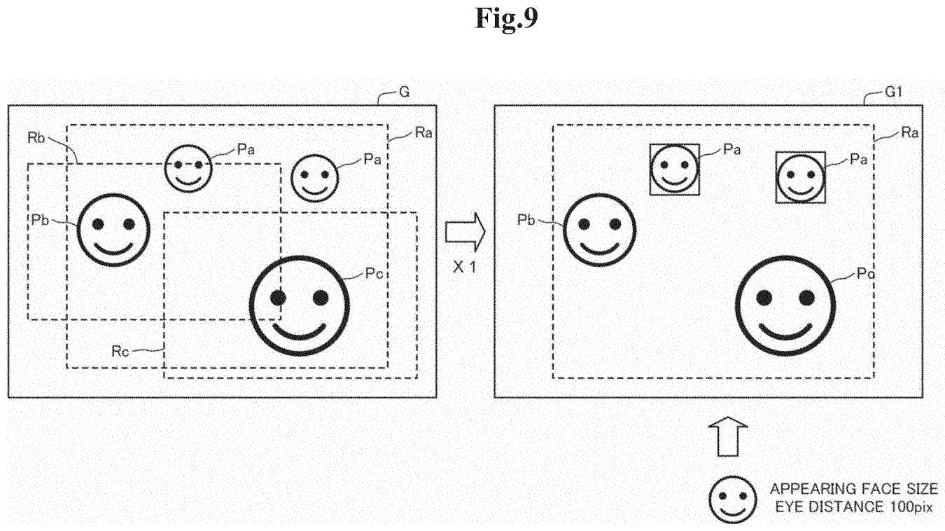

Here, an example of the face detection process by the object detecting unit 14 will be described with reference to FIGS. 9 to 11. First, the object detecting unit 14 changes the overall image size of a new captured image G to 1 time as shown in FIG. 9. Since the magnification is 1 time, the acquired new captured image G may be used without change. Then, the object detecting unit 14 sets a detection region Ra in a new captured image G1 after the image size has been changed to 1 time, and performs detection of a face having an eye distance of 100 pix only in the detection region Ra. Consequently, the face region of a person Pa enclosed by a rectangle appearing in the detection region Ra can be detected.

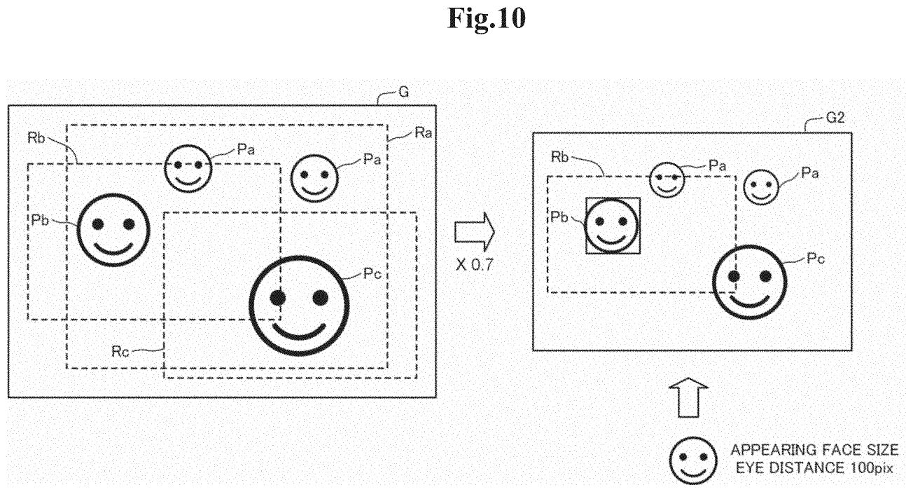

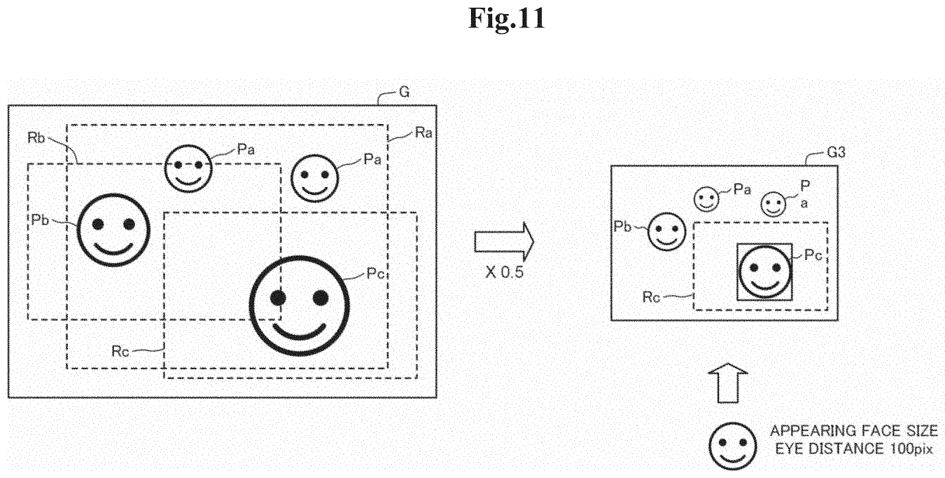

Further, the object detecting unit 14 changes the overall image size of the new captured image G to 0.7 times as shown in FIG. 10. Then, the object detecting unit 14 sets a detection region Rb in a new captured image G2 after the image size has been changed to 0.7 times, and performs detection of a face having an eye distance of 100 pix only in the detection region Rb. Consequently, the face region of a person Pb enclosed by a rectangle appearing in the detection region Rb can be detected. Further, the object detecting unit 14 changes the overall image size of the new captured image G to 0.5 times as shown in FIG. 11. Then, the object detecting unit 14 sets a detection region Rc in a new captured image G3 after the image size has been changed to 0.5 times, and performs detection of a face having an eye distance of 100 pix only in the detection region Rc. Consequently, the face region of a person Pc enclosed by a rectangle appearing in the detection region Rc can be detected. The object detecting unit 14 may change the overall image size of the new captured image G to 0.7 times and thereafter change this image size to 0.7 times to make the first image size to approximately 0.5 times.

Although the object detecting unit 14 performs a detection process on a new captured image by using a detection region R set by the region setting unit 13 as described above, a detection region R is not necessarily limited to being set by the region setting unit 13. For example, information of a detection region R as described above set by any means may be previously stored in the region information storing unit 16, and the object detecting unit 14 may retrieve and use the information of the detection region R to perform the detection process in the detection region R on a new image.

### [Operation]

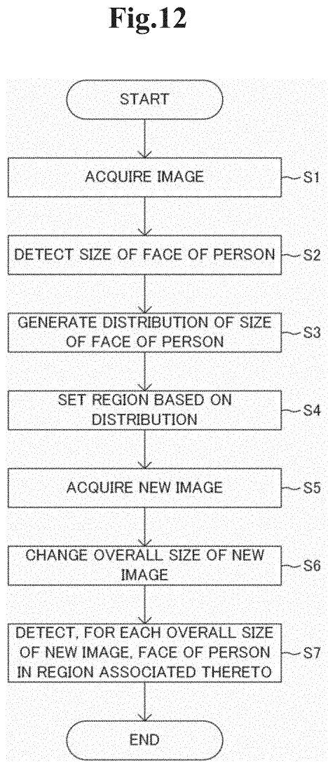

Next, an operation of the above information processing system will be described majorly with reference to a flowchart of FIG. 12. A process at steps S1 to step S4 described below is a process performed in advance as a process of setting a detection region R, and a process at steps S5 to S7 is a detection process performed on a new image acquired after the detection region R is set. However, the process of setting a detection region R at steps S1 to S4 does not necessarily need to be executed, and a detection region R set by any method may be stored in the information processing system in advance.

First, the information processing system captures an image of a target place by a camera C, and the detection apparatus 10 acquires the captured image (step S1). Then, the detection apparatus 10 detects the size of the face of a person P in the captured image (step S2). Here, as shown in FIG. 3, the detection apparatus 10 detects the eye distance of the person P, and stores so as to associate the detected eye distance of the person P with a division region r, which is information representing the position of the detected face of the person P on the captured image. The detection apparatus 10 performs detection of the eye distance of the person P on a plurality of captured images, and stores the position.

Subsequently, the detection apparatus 10 generates the distribution of the detected eye distance of the face of the person P (step S3). For example, as shown in FIG. 4, the detection apparatus 10 generates, for each of the division regions r obtained by dividing the captured image, a distribution d of the eye distance associated with the division region r. Then, by using the distribution of the detected eye distance of the person P, the detection apparatus 10 sets, for each reference eye distance, a detection region R so that a position where an eye distance determined to be identical to the value of the reference eye distance has been detected is included (step S4). For example, the detection apparatus 10 assumes 100 pix, 150 pix and 200 pix to be reference eye distances, and sets detection regions Ra, Rb and Rc corresponding to the respective reference eye distances as shown in FIG. 7. Then, the detection apparatus 10 stores so as to associate region information that specifies a position on the captured image of each of the set detection regions Ra, Rb and Rc with information that specifies the image size of a new captured image.

After that, every time a new captured image is captured by the camera C, the detection apparatus 10 acquires the new captured image (step S5) and performs a person detection process on the new captured image. At this time, the detection apparatus 10 changes the overall image size of the new captured image to 1 time, 0.7 times, and 0.5 times (step S6). Then, the detection apparatus 10 performs, in the captured image whose magnification has been changed to each of the magnifications, detection of a face having a specific eye distance (for example, 100 pix) only in any of the detection regions Ra, Rb and Rc associated with the magnification (step S7).

For example, as shown in FIG. 9, the detection apparatus 10 performs, in a new captured image G1 whose magnification has been changed to 1 time, detection of a face Pa having an eye distance of 100 pix only in a detection region Ra in the captured image G1. Moreover, as shown in FIG. 10, the detection apparatus 10 performs, in a new captured image G2 whose magnification has been changed to 0.7 times, detection of a face Pb having an eye distance of 100 pix only in a detection region Rb in the captured image G2. Moreover, as shown in FIG. 11, the detection apparatus 10 performs, in a new captured image G3 whose magnification has been changed to 0.5 times, detection of a face Pc having an eye distance of 100 pix only in a detection region Rc in the captured image G3.

As described above, in this example embodiment, the eye distance of a person P appearing in a captured image is detected first, and a detection region R is set for each eye distance in accordance with the appearing position. Then, at the time of a face detection process on a new captured image, the overall image size is changed, and the face detection process is performed only in a detection region R set in accordance with the changed image size. Consequently, there is no need to repeatedly perform the face detection process on the entire region of each new captured image whose image size has been changed. That is to say, it is sufficient to perform the face detection process only in one detection region for each changed image size of a new captured image. As a result, it is possible to increase the speed of the face detection process and reduce the load.

Although a case where the detection apparatus 10 detects the face of a person P in a captured image is illustrated above, a target to be detected may be any object. In this case, the detection apparatus 10 detects a predetermined size of an object to be a detection target instead of the eye distance of a person P, and sets a region in an image for each reference size in accordance with the predetermined size. Then, the detection apparatus 10 changes the magnification of a new image, and performs an object detection process only in a region set for each image whose magnification has been changed.

### <Second Example Embodiment>

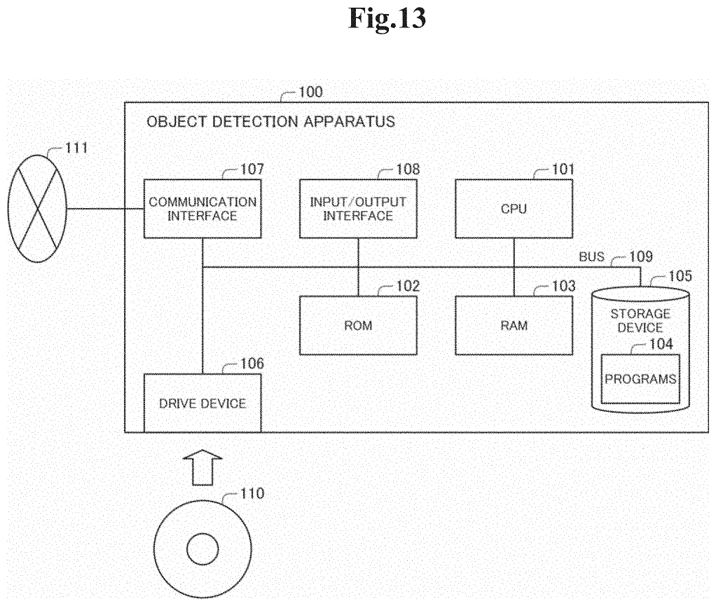

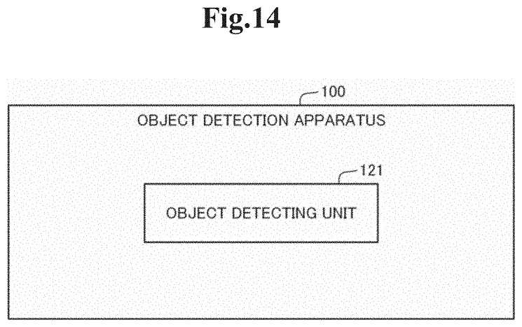

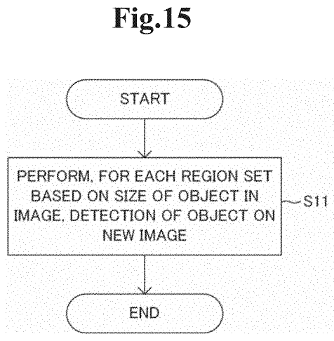

Next, a second example embodiment of the present invention will be described with reference to FIGS. 13 to 15. FIGS. 13 to 14 are block diagrams showing a configuration of an object detection apparatus in the second example embodiment, and FIG. 15 is a flowchart showing an operation of an image processing apparatus. In this example embodiment, the overview of the configurations of the detection apparatus 10 described in the first example embodiment and an object detection method is shown.

First, a hardware configuration of an object detection apparatus 100 in this example embodiment will be described with reference to FIG. 13. The object detection apparatus 100 includes one or a plurality of generally-used information processing apparatuses, and includes the following hardware configuration as shown below;
a CPU (Central Processing Unit) 101 (an arithmetic logic unit),
a ROM (Read Only Memory) 102 (a storage unit),
a RAM (Random Access Memory) 103 (the storage unit),
programs 104 loaded to the RAM 103,
a storage device 105 for storing the programs 104,
a drive device 106 that reads from and writes into a storage medium 110 outside the information processing apparatus,
a communication interface 107 connected to a communication network 111 outside the information processing apparatus,
an input/output interface 108 that inputs and outputs data, and
a bus 109 that connects the components.

Then, the object detection apparatus 100 can structure and include an object detecting unit 121 shown in FIG. 14 by acquisition and execution of the programs 104 by the CPU 101. The programs 104 are, for example, stored in the storage device 105 or the ROM 102 in advance, and are loaded to the RAM 103 and executed by the CPU 101 as necessary. The programs 104 may also be supplied to the CPU 101 via the communication network 101, or may be stored in the storage medium 110 in advance and retrieved by the drive device 106 and supplied to the CPU 101. However, the abovementioned object detecting unit 121 may be structured by an electronic circuit.

FIG. 13 shows an example of the hardware configuration of the object detection apparatus 100, and the hardware configuration of the object detection apparatus is not limited to the above case. For example, the object detection apparatus 100 may include part of the abovementioned configuration, for example, excluding the drive device 106.

Then, the object detection apparatus 100 executes an object detection method shown in the flowchart of FIG. 15 by the function of the object detecting unit 121 structured by the programs as described above.

As shown in FIG. 15, the object detection apparatus 100 performs, for each region in an image set based on a size of a specific object detected in the image, a process of detecting the specific object on a new image (step S11).

In this example embodiment, with the configuration as described above, the size of an object appearing in a captured image is detected first, and a region is set for each size in accordance with the appearing position. Then, a process of detecting the object is performed only in the set region on a new image. Consequently, there is no need to repeatedly performing the object detection process on the entire region of a new image. As a result, it is possible to increase the speed of the object detection process and reduce the load.

### <Supplementary Notes>

The whole or part of the example embodiments disclosed above can be described as the following supplementary notes. The outline of the configurations of an object detection apparatus, an object detection method and a program according to the present invention will be described below. However, the present invention is not limited to the following configurations.

### (Supplementary Note 1)

An object detection method comprising
performing, for each region in an image set based on a size of a specific object detected in the image, a process of detecting the specific object on a new image.

### (Supplementary Note 2)

The object detection method according to Supplementary Note 1, comprising
changing an overall size of the new image and performing, for each overall size of the new image, the process of detecting the specific object in the region in the new image.

### (Supplementary Note 3)

The object detection method according to Supplementary Note 2, comprising
performing the process of detecting the specific object in one region for each overall size of the new image.

### (Supplementary Note 4)

The object detection method according to Supplementary Note 2 or 3, comprising
performing, for each region in the new image, the process of detecting the specific object having a specific size.

### (Supplementary Note 5)

The object detection method according to any of Supplementary Notes 1 to 4, comprising:
associating the region set based on the size of the specific object with information specifying an image size of the new image to be a processing target; and
changing an overall size of the new image and performing, for each overall size of the new image, the process of detecting the specific object in the region in the new image associated with the information specifying the image size identical to the overall size.

### (Supplementary Note 6)

The object detection method according to any of Supplementary Notes 1 to 5, comprising:
detecting the size of the specific object in the image and setting the region in the image based on the size of the specific object; and
thereafter performing, on the new image, the process of detecting the specific object for each region.

### (Supplementary Note 7)

The object detection method according to Supplementary Note 6, comprising
setting, for each size determined to be identical to the size of the specific object according to a preset criterion, the region in the image including the specific object having the size determined to be identical.

### (Supplementary Note 8)

The object detection method according to Supplementary Note 6 or 7, comprising
generating, for each division region obtained by dividing the image into a plurality of regions, a distribution of the size of the specific object located in the division region, and setting the region based on the distribution.

### (Supplementary Note 9)

The object detection method according to Supplementary Note 8, comprising
generating, based on the distribution, a connection region obtained by connecting the division regions including the specific object having a size determined to be identical according to a preset criterion, and setting the region based on the connection region.

### (Supplementary Note 10)

The object detection method according to any of Supplementary Notes 6 to 9, comprising
setting the region so as to exclude a non-detection region that is a region where the specific object is not detected in the image.

### (Supplementary Note 11)

The object detection method according to any of Supplementary Notes 6 to 10, comprising:
performing detection of the size of the specific object in the image on a plurality of images; and
setting the region in the image based on the size of the specific object detected from the plurality of images.

### (Supplementary Note 12)

The object detection method according to any of Supplementary Notes 6 to 11, comprising
detecting a size of a face of a person as the specific object.

### (Supplementary Note 13)

An object detection apparatus comprising
an object detecting unit configured to perform, for each region in an image set based on a size of a specific object detected in the image, a process of detecting the specific object on a new image.

### (Supplementary Note 14)

The object detection apparatus according to Supplementary Note 13, wherein
the object detecting unit is configured to change an overall size of the new image and perform, for each overall size of the new image, the process of detecting the specific object in the region in the new image.

### (Supplementary Note 14.1)

The object detection apparatus according to Supplementary Note 14, wherein
the object detecting unit is configured to perform the process of detecting the specific object in one region for each overall size of the new image.

### (Supplementary Note 14.2)

The object detection apparatus according to Supplementary Note 14 or 14.1, wherein
the object detecting unit is configured to perform, for each region in the new image, the process of detecting the specific object having a specific size.

### (Supplementary Note 15)

The object detection apparatus according to any of Supplementary Note 13 to 14.2, comprising
a size detecting unit configured to detect the size of the specific object in the image; and
a region setting unit configured to set the region in the image based on the size of the specific object,
wherein the object detecting unit is configured to, after the region is set, perform the process of detecting the specific object for each region on the new image.

### (Supplementary Note 16)

The object detection apparatus according to Supplementary Note 15, wherein
the region setting unit is configured to set, for each size determined to be identical to the size of the specific object according to a preset criterion, the region in the image including the specific object having the size determined to be identical.

### (Supplementary Note 17)

The object detection apparatus according to Supplementary Note 15 or 16, wherein
the region setting unit is configured to generate, for each division region obtained by dividing the image into a plurality of regions, a distribution of the size of the specific object located in the division region, and set the region based on the distribution.

### (Supplementary Note 17.1)

The object detection apparatus according to Supplementary Note 17, wherein
the region setting unit is configured to generate, based on the distribution, a connection region obtained by connecting the division regions including the specific object having a size determined to be identical according to a preset criterion, and setting the region based on the connection region.

### (Supplementary Note 18)

The object detection apparatus according to any of Supplementary Notes 15 to 17.1, wherein:
the region setting unit is configured to associate the region set based on the size of the specific object with information specifying an image size of the new image to be a processing target; and
the object detecting unit is configured to change an overall size of the new image and perform, for each overall size of the new image, the process of detecting the specific object in the region in the new image associated with the information specifying the image size identical to the overall size.

### (Supplementary Note 19)

The object detection apparatus according to any of Supplementary Notes 15 to 18, wherein
the region setting unit is configured to set the region so as to exclude a non-detection region that is a region where the specific object is not detected in the image.

### (Supplementary Note 20)

A computer program comprising instructions for causing a processor of an information processing apparatus to execute
performing, for each region in an image set based on a size of a specific object detected in the image, a process of detecting the specific object on a new image.

### (Supplementary Note 21)

The computer program according to Supplementary Note 20, comprising instructions for causing the processor of the information processing apparatus to further execute:
detecting the size of the specific object in the image and setting the region in the image based on the size of the specific object; and
thereafter performing, on the new image, the process of detecting the specific object for each region.

The abovementioned programs can be stored by using various types of non-transitory computer-readable mediums and supplied to a computer. The non-transitory computer-readable mediums include various types of tangible storage mediums. Examples of the non-transitory computer-readable mediums include a magnetic recording medium (for example, a flexible disk, a magnetic tape, a hard disk drive), a magnetooptical recording medium (for example, a magnetooptical disk), a CD-ROM (Read Only Memory), a CD-R, a CD-R/W, and a semiconductor memory (for example, a mask ROM, a PROM (Programmable ROM), an EPROM (Erasable PROM), a flash ROM, a RAM (Random Access Memory). The programs may also be supplied to a computer by various types of transitory computer-readable mediums. Examples of the transitory computer-readable mediums include an electric signal, an optical signal, and an electromagnetic wave. The transitory computer-readable mediums can supply the programs to a computer via a wired communication path such as an electric wire and an optical fiber or via a wireless communication path.

Although the present invention has been described above with reference to the example embodiments and the like, the present invention is not limited to the above example embodiments.

The configurations and details of the present invention can be changed in various manners that can be understood by one skilled in the art within the scope of the present invention.

### DESCRIPTION OF NUMERALS

10 detection apparatus

11 image acquiring unit

12 size detecting unit

13 region setting unit

14 object detecting unit

15 image storing unit

16 region information storing unit

C camera

P person

100 image processing apparatus

101 CPU

102 ROM

103 RAM

104 programs

105 storage device

106 drive device

107 communication interface

108 input/output interface

109 bus

110 storage medium

111 communication network

121 object detecting unit

What is claimed is:

1. An object detection method comprising
performing, for each region in an image set based on a size of a specific object detected in the image, a process of detecting the specific object on a new image.

2. The object detection method according to claim 1, comprising
changing an overall size of the new image and performing, for each overall size of the new image, the process of detecting the specific object in the region in the new image.

3. The object detection method according to claim 2, comprising performing the process of detecting the specific object in one region for each overall size of the new image.

4. The object detection method according to claim 2, comprising
performing, for each region in the new image, the process of detecting the specific object having a specific size.

5. The object detection method according to claim 1, comprising:
associating the region set based on the size of the specific object with information specifying an image size of the new image to be a processing target; and
changing an overall size of the new image and performing, for each overall size of the new image, the process of detecting the specific object in the region in the new image associated with the information specifying the image size identical to the overall size.

6. The object detection method according to claim 1, comprising:
detecting the size of the specific object in the image and setting the region in the image based on the size of the specific object; and
thereafter performing, on the new image, the process of detecting the specific object for each region.

7. The object detection method according to claim 6, comprising
setting, for each size determined to be identical to the size of the specific object according to a preset criterion, the region in the image including the specific object having the size determined to be identical.

8. The object detection method according to claim 6, comprising
generating, for each division region obtained by dividing the image into a plurality of regions, a distribution of the size of the specific object located in the division region, and setting the region based on the distribution.

9. The object detection method according to claim 8, comprising
generating, based on the distribution, a connection region obtained by connecting the division regions including the specific object having a size determined to be identical according to a preset criterion, and setting the region based on the connection region.

10. The object detection method according to claim 6, comprising
setting the region so as to exclude a non-detection region that is a region where the specific object is not detected in the image.

11. The object detection method according to claim 6, comprising:
performing detection of the size of the specific object in the image on a plurality of images; and
setting the region in the image based on the size of the specific object detected from the plurality of images.

12. The object detection method according to claim 6, comprising
detecting a size of a face of a person as the specific object.

13. An object detection apparatus comprising:
at least one memory configured to store instructions; and
at least one processor configured to execute the instructions to
perform, for each region in an image set based on a size of a specific object detected in the image, a process of detecting the specific object on a new image.

14. The object detection apparatus according to claim 13, wherein the at least one processor is configured to execute the instructions to
change an overall size of the new image and perform, for each overall size of the new image, the process of detecting the specific object in the region in the new image.

15. The object detection apparatus according to claim 13, wherein the at least one processor is configured to execute the instructions to:
detect the size of the specific object in the image;
set the region in the image based on the size of the specific object; and
after the region is set, perform the process of detecting the specific object for each region on the new image.

16. The object detection apparatus according to claim 15, wherein the at least one processor is configured to execute the instructions to
set, for each size determined to be identical to the size of the specific object according to a preset criterion, the region in the image including the specific object having the size determined to be identical.

17. The object detection apparatus according to claim 15, wherein the at least one processor is configured to execute the instructions to
generate, for each division region obtained by dividing the image into a plurality of regions, a distribution of the size of the specific object located in the division region, and set the region based on the distribution.

18. The object detection apparatus according to claim 15, wherein the at least one processor is configured to execute the instructions to:
associate the region set based on the size of the specific object with information specifying an image size of the new image to be a processing target; and
change an overall size of the new image and perform, for each overall size of the new image, the process of detecting the specific object in the region in the new image associated with the information specifying the image size identical to the overall size.

19. The object detection apparatus according to claim 15, wherein the at least one processor is configured to execute the instructions to
set the region so as to exclude a non-detection region that is a region where the specific object is not detected in the image.

20. A non-transitory computer-readable medium having a computer program stored thereon, the computer program comprising instructions for causing a processor of an information processing apparatus to execute
performing, for each region in an image set based on a size of a specific object detected in the image, a process of detecting the specific object on a new image.

21. (canceled)
